(19) United States
(12) Patent Application Publication
(10) Pub. No.: US 2011/0089732 A1
(43) Pub. Date: Apr. 21, 2011

(54) CHILD SAFETY SEAT WITH A TRANSVERSE ENGAGING BASE

(75) Inventor: Cheng-Fan Yang, Tainan Hsien (TW)

(73) Assignee: LINK TREASURE LIMITED, Tortola (VG)

(21) Appl. No.: 12/904,576

(22) Filed: Oct. 14, 2010

Related U.S. Application Data
(63) Continuation of application No. 12/198,514, filed on Aug. 26, 2008.

(51) Int. Cl. A47D 1/10; B60N 2/28

(52) U.S. Cl. 297/256.16

(57) ABSTRACT

A child safety seat with a transverse engaging base is provided. The child safety seat has an engagement portion for engaging with the base in transverse direction. The base is formed with at least a transverse engaging space which includes a first upper abutting face, a second abutting face and a support face so as to receive and retain the child safety seat therebetween. A positioning element is operatively mounted between the child safety seat and the base, so as to releasably lock the child safety seat within the transverse engaging space.

### CROSS-REFERENCE TO RELATED PATENT APPLICATION

This application is a continuation application of a U.S. application Ser. No. 12/198,514, filed Aug. 26, 2008, entitled “CHILD SAFETY SEAT WITH A TRANSVERSE ENGAGING BASE”, Cheng-Fan Yang, which is incorporated herein by reference in its entirety.

### BACKGROUND OF THE INVENTION

1. Field of the Invention

The present invention relates generally to child safety seat which is releasably connected to a base in a transverse direction. More particularly, the base is formed with a transverse engaging space included at least an upper abutting face to prevent the child safety seat from roll over forwardly on the base.

2. Description of the Related Art

Child safety seats are in wide use. All of the states now require that some type of child seat be used in automobiles for use with children who are of a size whereby they cannot be protected by the standard seat belt arrangement of the automobile.

Child safety seats have been proposed which have multiple uses, and particularly which may be used with a base or used separately without the base. Each base is designed to mate with the associated seat and connected to a car seat.

Typically, the child safety seat is loaded onto an associated base downwardly and secured by a securing member. When the speed of the car is suddenly reduced by a head-on collision or braking in emergency, the inertia shall be applied to move the child safety seat forwardly. Once the securing member is failed or not be full engaged, the child safety seat will roll over forwardly, and that may fall or fly from the base.

### SUMMARY OF THE INVENTION

To overcome the shortcomings, the present invention intends to provide a child safety seat with a transverse engaging base to obviate the aforementioned problems. The child safety seat has an engagement portion for engaging with the base in transverse or lateral direction. The base is formed with at least a transverse engaging space which includes a first upper abutting face, a second abutting face and a support face so as to receive and retain the child safety seat therebetween. A positioning element is operatively mounted between the child safety seat and the base, so as to releasably lock the child safety seat within the transverse engaging space.

It would be more safe and convenient for a user to load the child safety seat transversely into the base. When inertia is applied, the upper abutting faces shall prevent the child safety seat to roll over forwardly. So as to enhance the safety to the child seat occupant.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective view of an embodiment of a child safety seat with a transverse engaging base according to the present invention;

FIG. 2 is a perspective view of the child safety seat according to the present invention;

FIG. 3 is a schematic view showing the child safety seat is loaded into a base and connected to a car seat;

FIG. 4 is a perspective view showing the base connected with a support leg;

FIG. 5 is a schematic view showing the child safety seat is loading into the base in transverse direction as indicated by the arrows;

FIG. 6 is a side view of the base with a transverse engaging space;

FIG. 7 is a schematic view showing the child safety seat is loaded into a base with a guide post;

FIG. 8 is a schematic view showing the guide post is guiding the child safety seat to rotate into the transverse engaging space; and

FIG. 9 is an enlarged fragmentary cross-sectional view of an alternative embodiment of the base which has two transverse engaging spaces.

### DETAILED DESCRIPTION OF THE PREFERRED EMBODIMENTS

Reference will now be made in detail to the preferred embodiments of the present invention, examples of which are illustrated in the accompanying drawings.

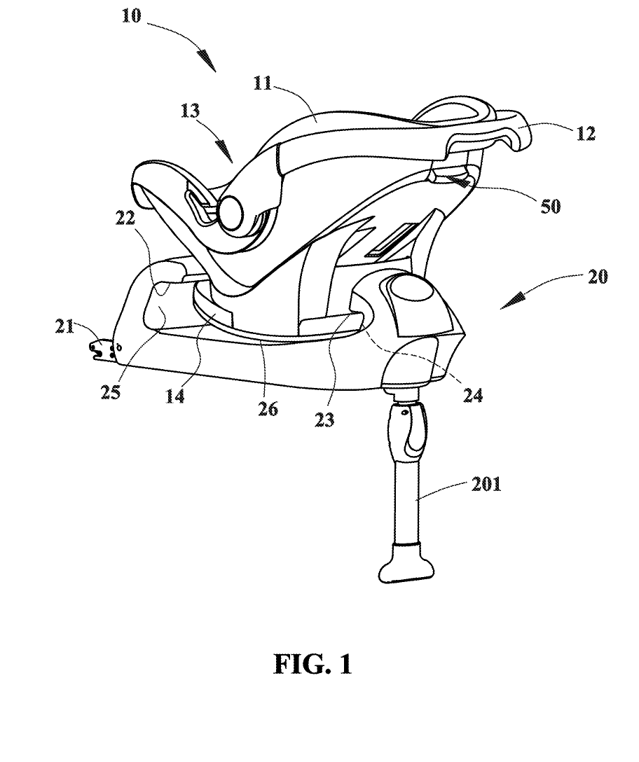

Referring to FIG. 1, an embodiment of the present invention includes a child safety seat 10, a base 20 and a positioning mechanism 50. As the child safety seat 10 is designed for engaging with the base 20 in transverse direction, the child safety seat 10 can be prevented from rolling over the base 20. The positioning mechanism 50 includes a positioning element 50 operatively mounted between the child safety seat 10 and the base 20, so as to releasably lock the child safety seat 10 within the transverse engaging space 28.

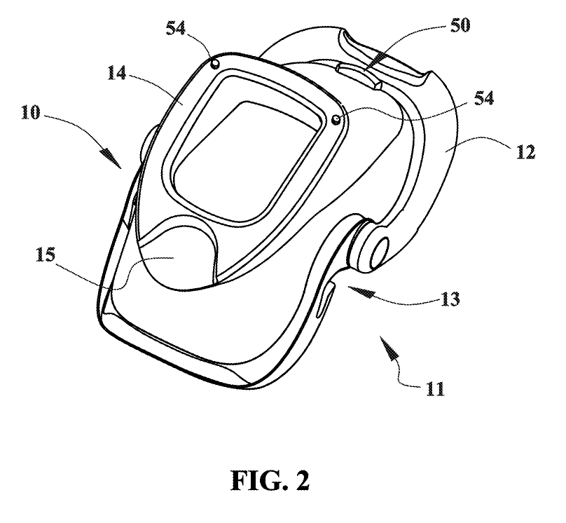

Referring to FIGS. 1 and 2, the child safety seat 10 includes a main body 11 and an engagement portion 14. The main body 11 has an accommodation space 13 for receiving a child sitting thereon. The lower end of the child safety seat 10 is protruded in longitudinal direction to form an engagement portion 14. For instance, the engagement portion 14 may be a plate fixed to the lower end of the child safety seat 10 protruded forwardly and/or rearwardly. Further, the child safety seat 10 has a rotatable handle 12 for carrying the child occupant with the child safety seat 10.

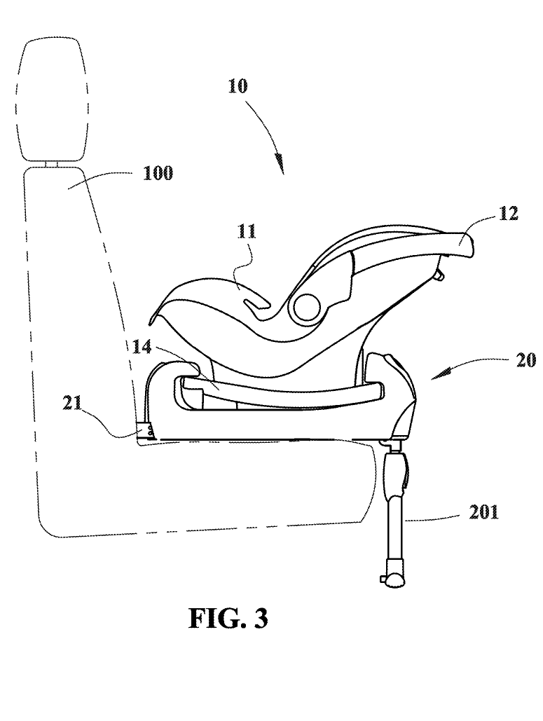

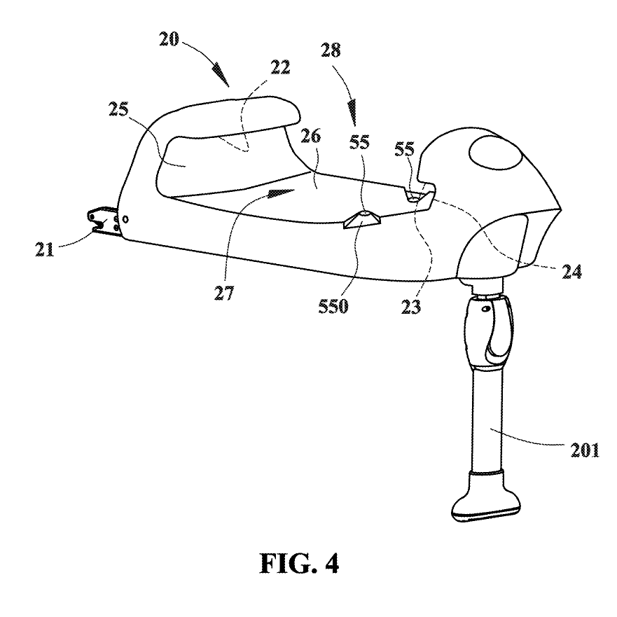

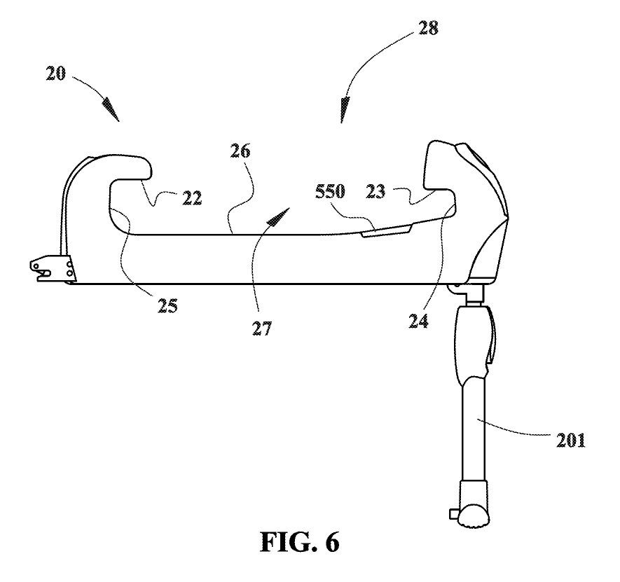

Referring to FIGS. 3 to 6, the child safety seat 10 is quick releasably connected to the car seat 100 via the base 20. One end of the base 20 has a securing device 21 for connecting to an ISO-FIX anchoring bar of the car. Alternatively, the base 20 can be secured to the car seat 100 by a standard safety seat belt.

The base 20 is formed with at least a transverse engaging space 28 which includes a first upper abutting face 22, a second abutting face 23 and a support face 26 so as to receive and retain the child safety seat 10 therebetween. The base 20 has an opened side way 27 that permits the child safety seat 10 to move into the transverse engaging space 28 for one side thereof. When a longitudinal inertia force is occurred by brake or hit something ahead, the upper abutting faces 22 and 23 shall prevent the child safety seat 10 from roll over forwardly.

Preferably, one end of the base 20 is connected and supported with a support leg 201. It will also be appreciated to make the support leg 201 with a structure of retractable and adjustable in length. Further, the base 20 has a front end face 24 and a rear end face 25 for limiting the child safety seat 10 in longitudinal direction thereof. Alternatively, the transverse engaging space 28 may be substantially contoured with the engagement portion 14, so as to limit the moving of the child safety seat 10.

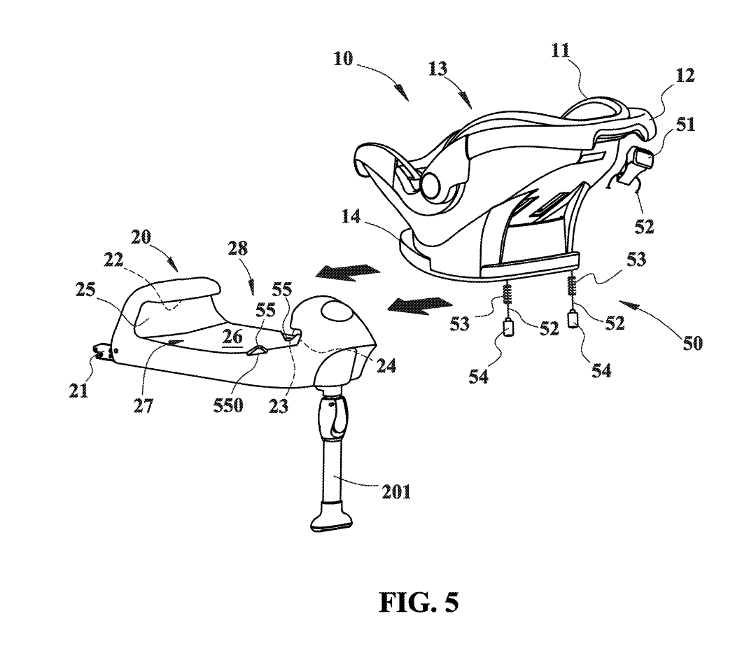

Referring to FIG. 5, the child safety seat 10 has a release actuator 12 associated with the positioning element 54 via a connecting member 52. The user can operate the positioning element 54 by pull the release actuator 12.

The base 20 has a positioning slot 55 for engaging with the positioning element 54, and the child safety seat 10 has a resilient element 53 for pressing the positioning element 54 to engage into the positioning slot 55. The support face 26 may be formed with a guide slot 550 for guiding the positioning element 54 to engage with the positioning slot 55.

The release actuator 12, the connecting member 52 and the resilient element 53 may be installed in either the child safety seat 10 or the base 20. The user can pull the release actuator 12 to retract the positioning element 54 moving against the biasing of resilient element 53, so as to release the engagement portion 14 from the transverse engaging space 28 through the opening side way 27.

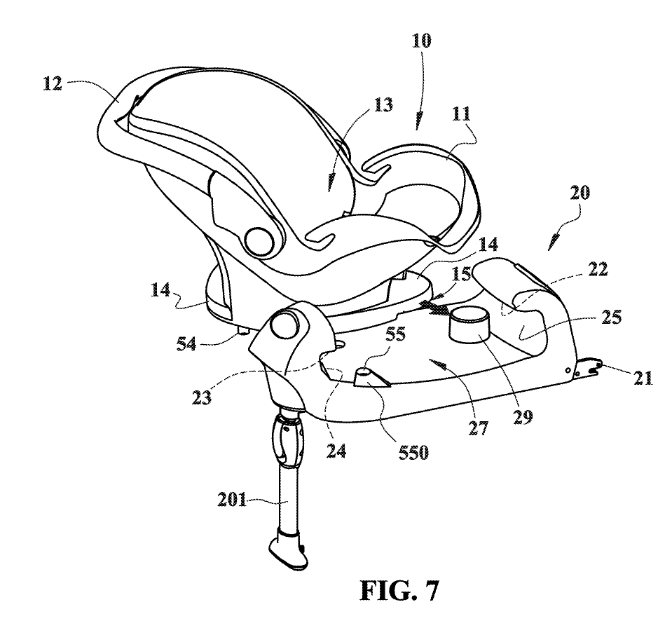

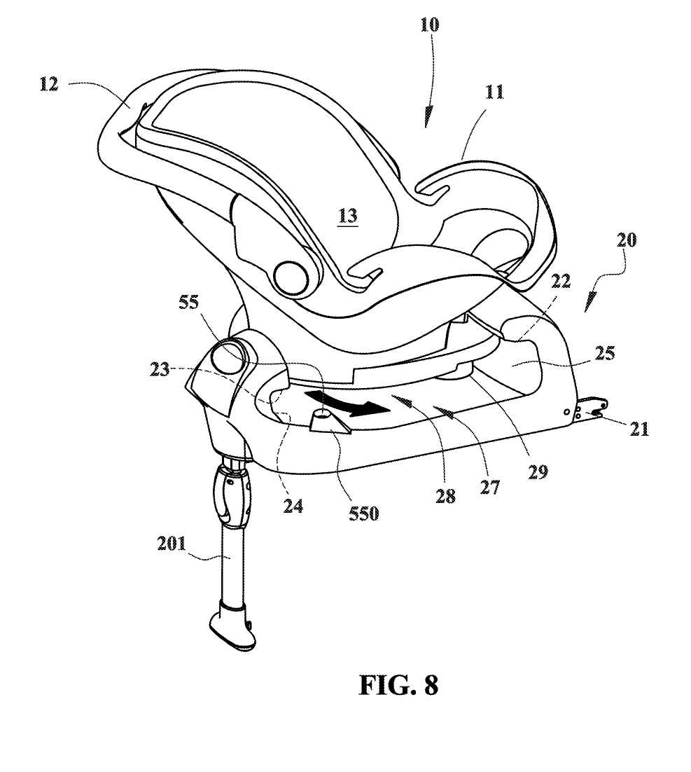

Turning now to FIGS. 2, 7 and 8, there are shown a guide post 29 formed on one end of the support face 26, and a guide slot 15 formed on the lower end of the child safety seat 10. When the user is moving the engagement portion 14 into the transverse engaging space 28, the guide post 29 will abut the guide slot 15, this will make the engagement portion 14 to rotate about the guide post 2, and finally guide the engagement portion 14 engaged within the transverse engaging space 28.

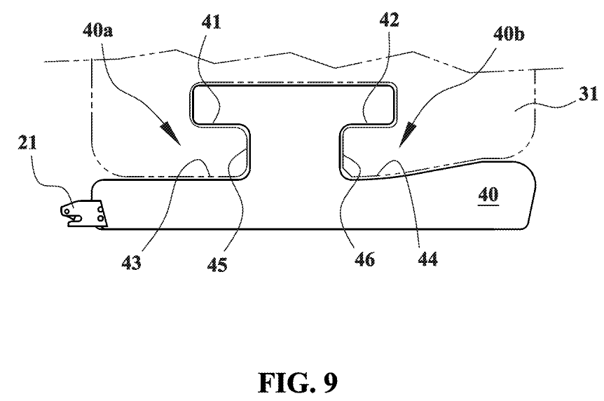

FIG. 9 is an enlarged fragmentary cross-sectional view showing an alternative embodiment of the base 40 of the present invention which has two transverse engaging spaces 40a and 40b and formed with a pair of upper abutting spaces 41 and 42, support faces 43 and 44, a front end face 45 and a rear end face 46, thereby to engage an engagement portion 31 with same contour.

Although certain embodiments in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A child safety seat with a transverse engaging base, comprising:
a child safety seat, having an engagement portion protruded in a longitudinal direction;
a base, having a support face having a front end and a rear end formed alone a transverse direction perpendicular to the longitudinal direction, a front end face and a rear end face extended longitudinally and upwardly from the front end and the rear end, respectively, of the support face, and a first upper abutting face and a second upper abutting face extended transversely and inwardly from the rear end face and the front end face, respectively, thereby defining a transverse engaging space with an opened side way between the front end face and the rear end face and between the support face and the first upper abutting face and the second upper abutting face for engaging the child safety seat, such that, in operation, the engagement portion of the child safety seat is transversely slided into the transverse engaging space from the opened side way, and received and retained therein; and
a positioning element, operatively mounted between the child safety seat and the base for releasably positioning the child safety seat in the transverse engaging space.

2. The child safety seat with a transverse engaging base of claim 1, wherein the child safety seat has a rotatable handle.

3. The child safety seat with a transverse engaging base of claim 1, wherein the engagement portion is formed at a lower portion of the child safety seat.

4. The child safety seat with a transverse engaging base of claim 1, wherein the engagement portion is protruded in the longitudinal direction from the lower portion of the child safety seat.

5. The child safety seat with a transverse engaging base of claim 1, wherein the transverse engaging space is substantially contoured with the engagement portion of the child safety seat.
